(19) United States
(12) Patent Application Publication
(10) Pub. No.: US 2009/0290450 A1
(43) Pub. Date: Nov. 26, 2009

(54) HEAD-MOUNTED DISPLAY APPARATUS FOR PROFILING SYSTEM

(76) Inventor: Daniel RIOUX, Laval (CA)

Correspondence Address: GOUDREAU GAGE DUBUC, 2000 MCGILL COLLEGE, SUITE 2200, MONTREAL, QC, H3A 3H3, CA

(21) Appl. No.: 12/512,554

(22) Filed: Jul. 30, 2009

Related U.S. Application Data
(62) Division of application No. 11/669,567, filed on Jan. 31, 2007.
Application No. 11/669,567 is a continuation-in-part of application No. 11/482,113, filed on Jul. 7, 2006, now abandoned.
Application No. 11/482,113 is a continuation of application No. 10/324,073, filed on Dec. 20, 2002, now Pat. No. 7,073,405.

(30) Foreign Application Priority Data
Dec. 20, 2001 (CA) 2,366,030

(51) Int. Cl. G01V 1/34

(52) U.S. Cl. 367/68

(57) ABSTRACT

A head-mounted display to visualize a medium through a surface by displaying an image characterizing the medium under the surface provided by a profiling system and referenced in the real environment of the user. An image of the medium under the surface is projected in front of one or both eyes of a person wearing the head-mounted display, in superimposition with the real environment of the user. The head-mounted display comprises a positioning sensor, such as an inertial positioning sensor, for determining its position and orientation in the real environment. As the user moves around the medium, the image of the medium is updated to display the medium as if it could be seen through the surface. In one embodiment of the invention, the image of the medium under surface is displayed in stereoscopy, the user thereby visualizing the medium in three dimensions.

### CROSS REFERENCE TO RELATED APPLICATIONS

This application is a divisional application of U.S. patent application Ser. No. 11/669,567, which is a continuation-in-part, and claims benefit under 35 USC §120 of now abandoned U.S. patent application Ser. No. 11/482,113 filed on Jul. 7, 2006, which is a continuation, and claims benefit under 35 USC §120 of U.S. patent application Ser. No. 10/324,073 filed on Dec. 20, 2002 and issued on Jul. 11, 2006 to U.S. Pat. No. 7,073,405, which claims the benefit of priority under 35 USC §119 from Canadian Patent Application no. 2,366,030 filed on Dec. 20, 2001. All documents above are incorporated herein in their entirety by reference.

### FIELD OF THE INVENTION

The present invention relates to the field of non-intrusive testing of a medium located under a surface. More specifically, the present invention is concerned with the display of the characterization of a medium under a surface.

### BACKGROUND OF THE INVENTION

In the field of geophysical exploration for example, non-intrusive techniques have been sought and developed as a supplement or an alternative to conventional in-situ testing techniques involving boring because these techniques are non-destructive. In some cases where boring is not feasible, for example in granular soils, such non-intrusive techniques are the only way to explore the underground. Also, they generally are more cost-effective.

Non-intrusive techniques are also used for exploring a medium situated under a surface in various other fields, for example, for assessing the structural conditions of roads, of bridges, of bar joints in buildings, of concrete walls, etc., or for detecting subsurface features, such as a void, hidden substructure and bearing capacity, in mining or military applications.

Typically, two dimensional or three dimensional profiles of a section of the characterized medium or analytical data of the characterized medium are displayed on a computer monitor. The displayed data may not be convenient for a non-expert user to appreciate and interpret the displayed data for its practical use of the characterization.

Therefore, in spite of the efforts in the field, there is still a need for a system allowing profiling of a medium under a surface and convenient display of the characterization data.

### SUMMARY OF THE INVENTION

In assessing the structural conditions of roads, of bridges, of bar joints in buildings, of concrete walls, etc., or in detecting subsurface features in mining or military applications, it would be convenient to visualize the medium under the surface in three dimensions. It would be even more convenient, to visualize the medium under the surface in superimposition with the real-world surface, as if the user could see through the surface, such that the user can visualize the position of subsurface features in the real environment. In accordance with an aspect of the invention, a user wears a head-mounted display similar to virtual reality goggles for displaying images of the medium under the surface referenced in the real environment, preferably in stereoscopy. The images are superimposed with the real environment of the user so that the user can walk or move around the surface and visualize the medium under the surface in three dimensions as if he could see through the surface.

Accordingly, the invention provides a head-mounted display to visualize a medium through a surface by displaying an image of a characterization of the medium under the surface provided by a profiling system and referenced in the real environment of the user. An image of the medium under the surface is projected in front of one or both eyes of a person wearing the head-mounted display, in superimposition with the real environment of the user. The head-mounted display comprises a positioning sensor, such as an inertial positioning sensor, for determining its position and orientation in the real environment. As the user moves around the medium, the image of the medium is updated to display the medium as if it could be seen through the surface. In one embodiment of the invention, the image of the medium under surface is displayed in stereoscopy, the user thereby visualizing the medium in three dimensions.

For example, such head-mounted display may advantageously be used by an operator of heavy equipment, such as a backhoe, in excavation projects. Using the head-mounted display, the operator sees the surface as a semitransparent material and can see pipelines or obstacles under the surface and adjust his operation consequently. Another example is the use of the head-mounted display in substructure inspection. The head-mounted display provides the visualization of zones of different densities under a surface. The inspector may then examine the substructure through the surface. Furthermore, in well drilling applications, the number and placement of blasting charges can be optimized by visualizing the underground and the drilling shaft.

One aspect of the invention provides a head-mounted display apparatus for use by a user to visualize a characterization of a subsurface medium. The display apparatus comprises an input, a positioning sensor, a processing unit and a first display system. The input is for receiving a model characterizing the subsurface medium in a three-dimensional representation, in a reference system. The model is provided using a profiling system. The positioning sensor is for sensing a position and orientation of a first eye of the user in the reference system. The processing unit is for perspectively projecting the model on a first surface located in front of the first eye with the first position and orientation, to provide a first image characterizing the subsurface medium. The first display system is for displaying, on the first surface, the first image characterizing the subsurface medium in superimposition with a first image of a real environment in front of the first eye.

Another aspect of the invention provides a system for use by a user to visualize a characterization of a subsurface medium. The system comprises a profiling system for providing the characterization of the subsurface medium, a three-dimensional model processor for processing the characterization of the subsurface medium to provide a model characterizing the subsurface medium in a three-dimensional graphical representation, in a reference system, and a head-mounted display device. The head-mounted device has an input for receiving the model, a positioning sensor for sensing a position and orientation of a first eye of the user in the reference system, a processing unit for perspectively projecting the model on a first surface located in front of the first eye with the position and orientation, to provide a first image characterizing the subsurface medium, and a first display system for displaying, on the first surface, the first image characterizing the subsurface medium in superimposition with an image of a real environment in front of the first eye.

Another aspect of the invention provides a method for a user to visualize a characterization of a subsurface medium. The method comprises providing the characterization of the subsurface medium; processing the characterization of the subsurface medium to provide a model characterizing the subsurface medium in a three dimensional graphical representation, in a reference system; sensing a first position and orientation of a first eye of the user in the reference system; defining a first surface located in front of the first eye; perspectively projecting the model on a first surface located in front of the first eye to provide a first image characterizing the subsurface medium; providing an image of a real environment in front of the first eye; and displaying on the first surface the first image characterizing the subsurface medium in superimposition with the image of a real environment in front of the first eye.

Another aspect of the invention provides a head-mounted display apparatus for use by a user to visualize a characterization of a subsurface medium. The display apparatus comprises an input, a positioning sensor, a processing unit and a first display system. The input receives a model characterizing the subsurface medium in a three-dimensional representation, in a reference system. The positioning sensor senses a position and orientation of a first eye of the user in the reference system. The processing unit perspectively projects the model on a first surface located in front of the first eye with the first position and orientation, to provide a first image characterizing the subsurface medium. The first display system displays, on the first surface, the first image characterizing the subsurface medium in superimposition with a first image of a real environment in front of the first eye.

Another aspect of the invention provides a method for referencing a head-mounted display device in a global reference system. The method comprises: providing three target points disposed in the global reference system and defining a target plane; displaying a first reticle to a first eye and a second reticle to a second eye of the head mounted display device; aligning the first and second reticles from one another; aligning the reticles to a first target point and reading a first position and orientation of the head-mounted display device in a device reference system; aligning the reticles to a second target point and reading a second position and orientation of the head-mounted display device in a device reference system; aligning the reticles to a third target point and reading a third position and orientation of the head-mounted display device in a device reference system; calculating a translation matrix between the global reference system and the device reference system using the first, second and third positions and orientations; and saving the calculated translation matrix in memory.

Another aspect of the invention provides a head-mounted display apparatus for use by a user to visualize a characterization of a subsurface medium. The display apparatus comprises an input, a memory, a positioning sensor, a processing unit and a pair of display systems. The input receives, from a model processor, a model characterizing the subsurface medium in a three-dimensional graphical representation, in a reference system. The memory saves the model for the input to be disconnected from said model processor after saving the model. The positioning sensor senses a position and orientation of the head-mounted display apparatus in the reference system. The processing unit provides a pair of stereoscopic images characterizing the subsurface medium, from the model and the position and orientation. The stereoscopic display system displays, in front of the eyes of the user, a pair of stereoscopic images characterizing the subsurface medium in superimposition with a pair of images of a real environment.

Other objects, advantages and features of the present invention will become more apparent upon reading of the following non-restrictive description of specific embodiments thereof, given by way of example only with reference to the accompanying drawings.

### BRIEF DESCRIPTION OF THE DRAWINGS

In the appended drawings:

FIG. 1 is a front view of head-mounted display to be used in a display device for visualizing a medium through a surface, in accordance with an example embodiment of the invention wherein the head-mounted display has a see-through display screen in front of each eye;

FIG. 2 is a perspective view of head-mounted display to be used in a display device for visualizing a medium through a surface, in accordance with another example embodiment of the invention wherein the head-mounted display has a camera in front of each eye;

FIG. 3 is a schematic illustrating the projection of a three-dimensional model onto a single surface;

FIG. 4 is a schematic illustrating the projection of a three-dimensional model onto two surfaces, one for each eye;

FIG. 5 is a block diagram illustrating a display device in accordance with an example embodiment of the invention;

FIG. 6 is a schematic illustrating the referencing of head-mounted display in a reference system; and

FIG. 7 is a flow chart illustrating a method for referencing the head-mounted display in a reference system.

It will be noted that throughout the appended drawings, like features are identified by like reference numerals.

### DESCRIPTION OF ILLUSTRATIVE EMBODIMENTS

The present invention is illustrated in further details by the following non-limiting examples.

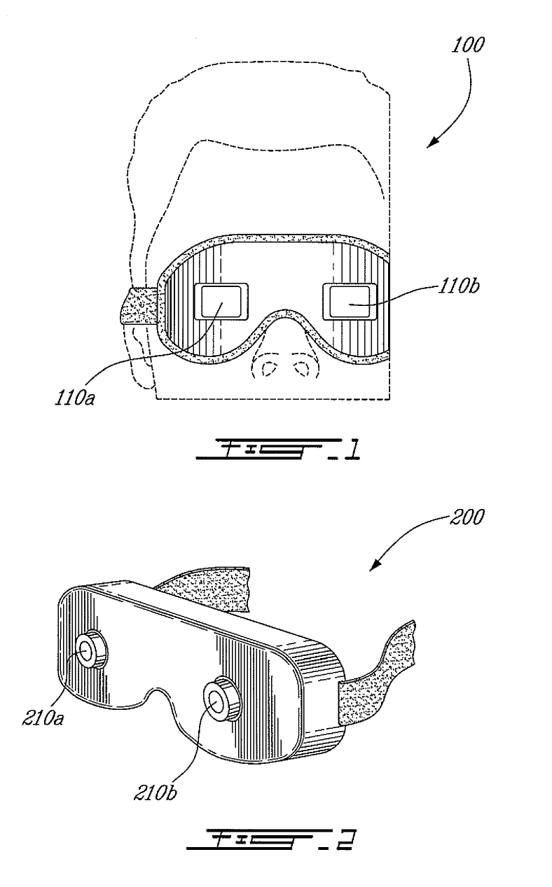

Now referring to the drawings, FIG. 1 shows an example of a head-mounted display 100 to be used for visualizing a medium through a surface. The head-mounted display 100 is adapted to be worn in front of the eyes of a user and have two see-through screens 110a, 110b that transmits light such that the user can directly see the real environment in front of his/her eyes through the see-through screens 110a, 110b. An image of the medium under the surface is projected on each see-through screen 110a, 110b. The images provided on the right and the left eye corresponds to a graphical representation of a characterization model of the medium in stereoscopy such that the characterization of the medium appears in three-dimensions to the user. The images are updated in real-time as the user moves around the characterized medium such that the user visualizes the characterization of the medium as if he/she could see through the surface. The see-through screens 110a, 110b can use see-through organic light-emitting diode devices (see the LE-750a series from Liteye Systems Inc.).

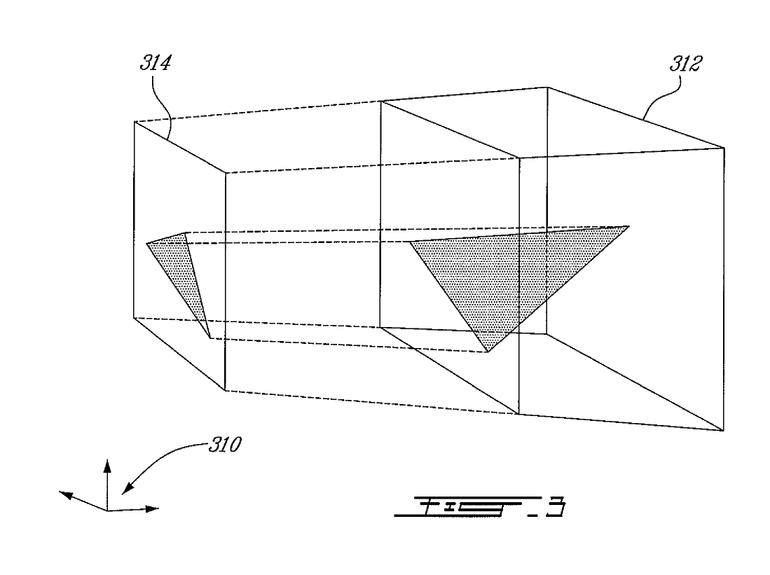

FIG. 2 shows another example of a head-mounted display 200 to be used for visualizing a medium through a surface. As the head-mounted display 100 of FIG. 1, the head-mounted display of FIG. 2 is adapted to be worn in front of the eyes of a user but has a camera 210a, 210b disposed in front of each eye in order to acquire images of the real environment in front of the user as he/she could see it if he/she did not wear the head-mounted display 200. The images captured by the cameras 210a, 210b are displayed in real time in front of the eyes of the user using two display systems. For example, each display system may use a liquid-crystal diode device or an organic light-emitting diode device. The images of the real environment are updated in real time such that the user can see the world in stereoscopy as he/she could see it if he/she did not wear the head-mounted display 200. However, superimposed with the images of the real environment, are images characterizing the medium under the surface in stereoscopy. Generally, the result of the head-mounted display of FIG. 2 is similar to the result of the head-mounted display of FIG. 1. The head-mounted display 200 of FIG. 2 may use cameras 210a, 210b sensitive to infrared radiations, which are turned into an image displayed using the display systems. Such head-mounted display 200 is particularly useful for use in night-vision or in low-light environment.

Other head-mounted displays are also contemplated. A single-eye head-mounted display uses only one display system for displaying images of the subsurface medium to only one eye. The single-eye configuration advantageously let the second eye free of any alteration of its vision but the medium is only represented in two dimensions.

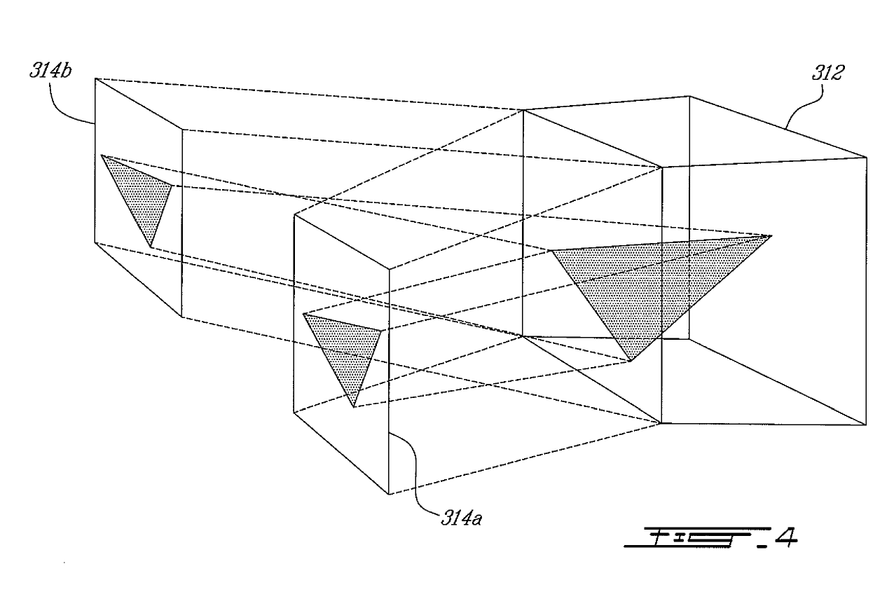

FIG. 3 illustrates the perspective projection of a three-dimensional (3D) characterizing model 312 of a subsurface medium onto a single surface 314, a plane in this case, to provide an image characterizing the subsurface medium. A 3-D model 312 characterizing the subsurface medium is provided in reference to a reference system 310. The illustrated case corresponds to a head-mounted display wherein an image characterizing the medium is only provided in front of one of the both eyes of a user (single-eye configuration) or the wherein the same image is provided in mono vision to both eyes. For example, in mono vision, a single camera could be provided on the head-mounted display to provide an image of the real environment. The same image would the be displayed to both eyes.

It is noted that the projection can be performed on a curved surface if the screen onto which the image is to be projected is curved.

A tomography characterizing the subsurface medium is obtained from the profiling system described in the U.S. Pat. No. 7,073,405 issued on Jul. 11, 2006, the description of which being incorporated by reference herein. The profiling system provides a characterization of the subsurface medium using sensors disposed on the surface and detecting the acceleration of shear waves induced in the subsurface medium under test by means of an excitation generated by an impulse generator. The sensors may be disposed to cover the whole surface under test or they may be repositioned during the characterization procedure to cover a larger surface or to provide better definition of the characterization. A user-computing interface processes the acceleration signal received from the sensors to provide a tomography characterizing the medium. The tomography comprises physical and mechanical characteristics or other analytical data of the medium.

In order to provide a 3-D characterizing model 312, the tomography is provided to a 3-D model processor which performs juxtapositions and interpolations of the tomographies using tridimensional analysis and geology-based algorithms. The provided 3-D characterizing model 312 is a graphical representation of the characterization of the medium in three dimensions. In one embodiment, the 3-D model processor uses a software especially designed for geotechnical applications, such as the 3D-GIS module provided by the company Mira Geoscience and running on a GOCAD software. The provided 3-D characterizing model 312 comprises characteristics such as shear velocity, density, Poisson's ratio, mechanical impedance, shear modulus, Young's modulus, etc. Further processing may provide various data such as the liquefaction factor, depth of the rock, depth of the base course, and such.

The provided 3-D characterizing model 312 is provided in reference to the reference system 310. As will be discussed hereinafter, the relative position and orientation between the head-mounted display 100 or 200 and the reference system is sensed and updated in real-time as the user moves or turn his/her head to look at a different region of the medium. This is done by the use of a positioning sensor located in the head-mounted display. As the user moves around the medium, the image displayed in front of the eyes of the user is updated to provide a graphical representation of characteristics of the medium as if it could be seen through the surface. Accordingly, the surface 314 located in front one eye of the user (in the head-mounted display) is defined in the reference system. It corresponds to the position of the screen onto which the image is to be displayed in the real environment. As shown in FIG. 3, the 3-D characterizing model is then perspectively projected on the projection surface 314 by a processing unit according to the sensed position and orientation of the eye, to provide an image characterizing the medium. This image is displayed in front of the eyes of the user. The displayed image is a graphical representation of the relevant characteristics of the medium and the represented features are located on the image to simulate as if the surface was sufficiently transparent to let the user see the graphical representation of features through the surface. The image characterizing the medium is displayed in superimposition with an image of the real environment in front of the eye of the user corresponding to the image that the user would see if he/she did not wear the head-mounted display. The image of the real environment is either provided by the use of a see-through screen (see FIG. 1), the image being simply transmitted through the screen, or by the use of a camera disposed in front the eye (see FIG. 2), the image from the camera being superimposed numerically with the image characterizing the medium using image processing algorithms. The projection scheme of FIG. 3 is used in a head-mounted display having a single display system for displaying an image of the subsurface medium only to one of the eyes. It is also used in mono vision head-mounted display devices having two display systems, one for each eye.

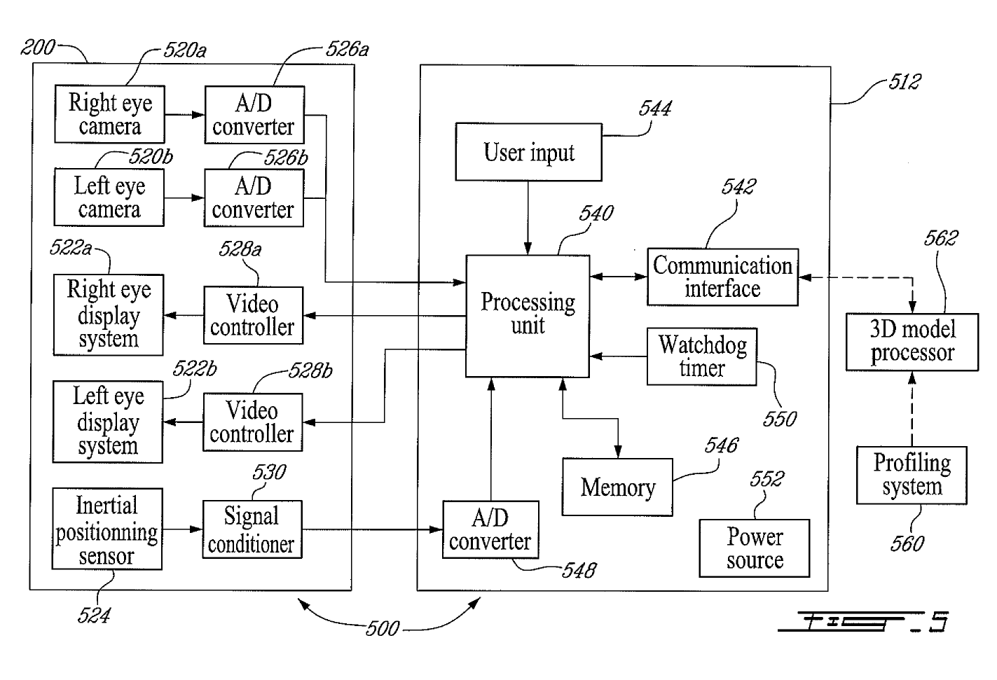

FIG. 4 illustrates the perspective projection of the 3-D model 312 onto two surfaces 314a, 314b, one for each eye, to provide a visualization of the medium in stereoscopy. The only difference with the illustration of FIG. 3 is that FIG. 4 illustrates a case where the head-mounted display provides the user with a different image characterizing the medium for each eye such that a 3-D perception is provided. The images displayed in front of the right eye and the left eye are provided according to the above description of FIG. 3. However, two projection surfaces, i.e. a right surface 314a and a left surface 314b are defined in front of the right and left eyes according to the sensed position and orientation of the head-mounted display in the reference system, and a different projection of the 3-D characterizing model is performed for each eye according to their respective position and orientation. A 3-D perspective of the graphical representation of the medium under the surface is thereby provided.

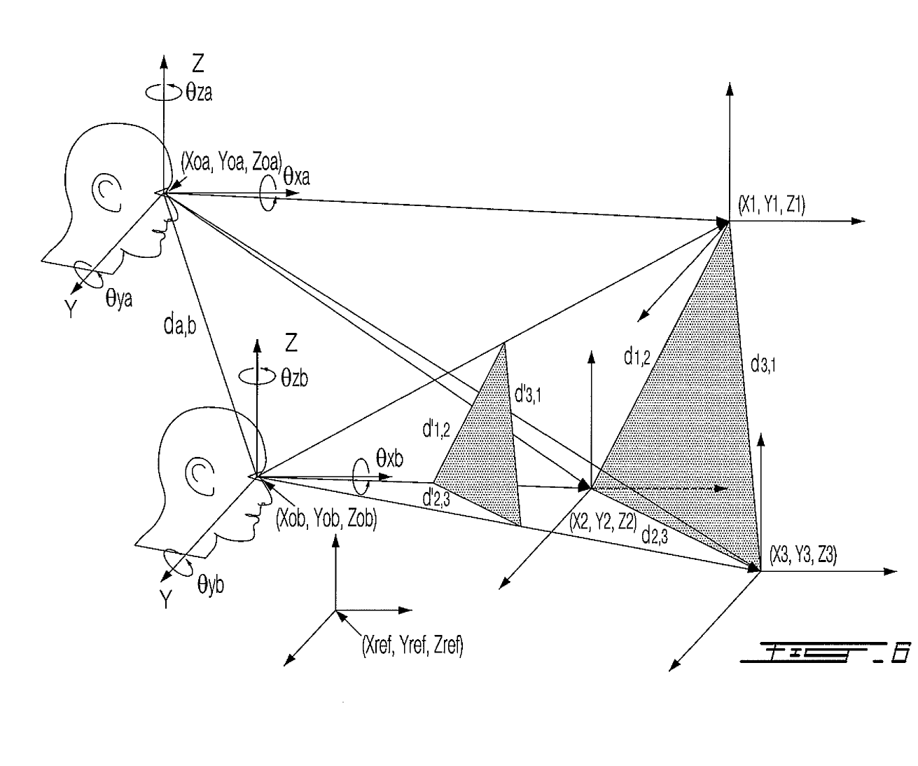

FIG. 5 illustrates the various functional blocks of a display device 500 comprising head-mounted display 200 to be worn by a user to visualize a characterization of the subsurface medium, and a control unit 512 carried by the user as he/she moves relative to the surface and which processes data for generating the images to be displayed to the user. The control unit 512 receives a 3-D characterizing model from a 3-D model processor 562 as described hereinbefore. The 3-D characterizing model is provided by the 3-D model processor 562 by processing a tomography characterizing the medium under the surface provided by a profiling system 560 as the one described in U.S. Pat. No. 7,073,405 issued on Jul. 11, 2006.

The head-mounted display 200 and the control unit 512 communicates using any wire protocol such as the Universal Serial Bus protocol or the Firewire protocol, or any wireless link protocol such as a radio-frequency or an infrared link. In the illustrated embodiment, the head-mounted display 200 and the control unit 512 are wired but in an alternative embodiment, both units have a wireless communication interface to communicate with each other and each unit has its own power source.

Video cameras 520a, 520b are disposed respectively in front of the right eye and the left eye to acquire images of the real environment in front of the right eye and the left eye. The video cameras continuously provide a video signal such that the image of the real environment is continuously updated as the user moves relative to the surface. The video signal is converted to a digital signal using A/D converters 526a and 526b before being provided to the control unit 512.

The head-mounted display 200 has a display system 522a, 522b for each eye to visualize the medium under the surface in stereoscopy. The display systems 522a, 522b are respectively controlled by the video controllers 528a, 528b. The video signal is provided to the video controllers 528a, 528b by the control unit 512.

A positioning sensor 524, i.e. an inertial positioning sensor based on accelerometers, is provided in the head-mounted display 200 for determining its position and orientation in the real environment. As the user moves around the medium, the position and orientation of the head-mounted display are sensed and provided to the control unit 512 after amplification and signal conditioning using the signal conditioner 530. The signal conditioner 530 comprises an automatic gain analog amplifier and an anti-aliasing filter. The positioning sensor 524 comprises a translation triaxial accelerometer positioning sensor and a rotation triaxial accelerometer positioning sensor to provide both position and orientation of the head-mounted display. The present description assumes that the head-mounted display 200 has been previously referenced in the reference system of the 3-D characterizing model. A method for referencing the head-mounted display in the reference system will be described hereinafter. Using the position and orientation of the head-mounted display in the reference system, the control unit 512 determines the position and orientation of each eye using calibration parameters. An analog positioning signal is provided to the control unit 512 which has an A/D converter 548 for digital conversion of the positioning signal.

The digital positioning signal and the digital video images are provided to a processing unit 540. The processing unit also receives the 3-D characterizing model from the communication interface 542 and stores it in memory 546. Accordingly, after the characterization of the medium under the surface is completed by the profiling system 560 and the resulting characterization is converted into a 3-D characterizing model by the 3-D model processor 562, the 3-D model is transmitted to and saved in the display device 500 for use by the head-mounted display. When the transmission is completed, the 3D-model processor 562 can be disconnected and the user is free to move relative to the medium while carrying the display device 500. The processing unit also receives commands from the user input 544 to be used during the referencing procedure, for controlling the display in the head-mounted display and so on. The user input 544 comprises buttons and a scroll wheel or other means for inputting commands. Furthermore, the control unit 512 also has a power source 552 and a watchdog timer 550 for the control unit 512 to recover from fault conditions.

The processing unit 540 receives the 3-D characterizing model and the sensed position and orientation of the head-mounted display 200. Using predetermined calibration (position and orientation of both eyes in reference with the sensor) and referencing parameters (position and orientation of the sensor in the reference system) of the head-mounted display 200, the processing unit performs the appropriate calculations and image processing to provide an image characterizing the medium to be displayed on the stereoscopic display systems 522a, 522b.

Furthermore, graphical representation parameters that are suitable for a particular application can be selected using the user input 544. A plurality of graphical representation profiles may be registered and the user may simply load the representation profiles suitable for his application. Examples of parameters that can be controlled are opacity/transparency of the graphical representation of the subsurface medium and of the real environment surface, the color palette, depth of the medium to be graphically represented, a depth of medium to be removed from the graphical representation, the display of specific data on mechanical structures, the display of informative data concerning the inside and the outside of the medium, the display of presence/absence of a given characteristic in the medium. For example, only the regions of the medium corresponding to a specific ore, may be graphically represented. The presence of ore is identified using its density and shear wave velocity. Regions corresponding to undersurface water or other characteristics may also be selected to be graphically represented.

The processing unit 540 has other utility programs for reacting to requests, performing the referencing of the head-mounted display 200 in the reference system of the 3-D model, for providing various informative displays on the display systems 522a, 522b and to adapt the display to a stereoscopic vision or mono vision as selected by the user.

In the illustrated embodiment, the head-mounted display 200 uses cameras 520a, 520b to provide the image of the real environment but, in an alternative embodiment, a head-mounted display 100 such as the ones illustrated in FIG. 1 is used and no cameras 520a, 520b are required. Accordingly the A/D converters 526a, 526b are also removed. A single display system 522a could also be used in a single-eye head-mounted display.

Alternatively, other inertial guidance systems such as a gyroscope-based system, a Global Positioning System or a combination of technologies could be used instead of the inertial positioning sensor 524.

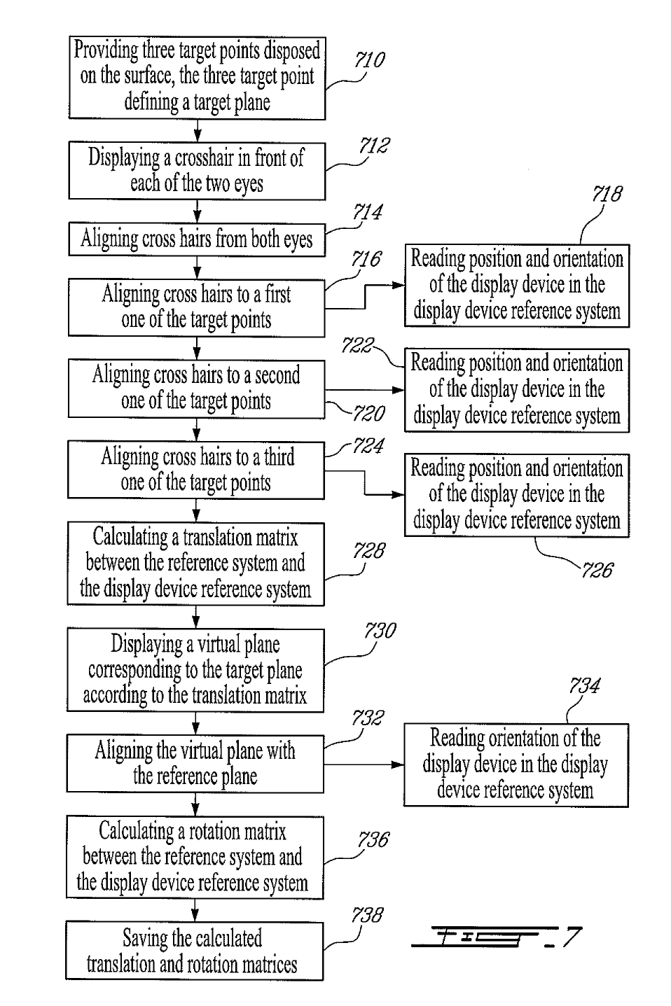

Turning to FIGS. 6 and 7, a method for referencing the head-mounted display, and consequently the position (Xo, Yo, Zo) and orientation (.theta.x, .theta.y, .theta.z) of each eye, in the reference system (Xref, Yref, Zref) of the 3-D model is now described. The method assumes the use of stereoscopic head-mounted display. The referencing method begins in 710 by providing three target points ((X1, Y1, Z1); (X2, Y2, Z2); (X3, Y3, Z3)) disposed on the surface of the medium. The three target points define a target plane and the distances d.sub.1,2, d.sub.2,3, d.sub.3,1 between the three targets points are known. Accordingly, the 3-D model contains positions of three target points in its reference system. The target points are typically the position of three of the profiling sensors used by the profiling system for the characterization of the medium. Since the 3-D model is defined relative to the position of the sensors, the reference system (Xref, Yref, Zref) can be inferred from these positions. Accordingly, while the other profiling sensors may be removed, at least three reference sensors should be left in place after the profiling process for use in the referencing process.

According to step 712, a reticle, i.e. crosshair, is displayed on both display systems of the head-mounted display, i.e. in front of both eyes. In 714, the user aligns the crosshairs from both eyes using the user input, such that the crosshairs are seen by the user as a single one. In 716, the user aligns the crosshairs to a first target point (X1 Y1, Z1). Typically, the sensors that should be used as target points have a different color or have a distinctive element for the user to identify them. In 718, the user presses a user button or uses any other input means (user input 544) to input to the control unit that the target is aligned and the control unit consequently reads the position and orientation (not illustrated) of the head-mounted display provided by the position sensor. The read position and orientation are given relative to the head-mounted display's system (as defined during the initialization process of the head-mounted display). The read position and orientation are kept for further calculations.

Then, in step 720, the user aligns the crosshairs to a second target point (X2, Y2, Z2). In 722, the user inputs to the control unit that the target is aligned and the control unit consequently reads the position and orientation (not illustrated) of the head-mounted display provided by the position sensor. These read position and orientation are also kept for further calculations.

In step 724, the user aligns the crosshairs to a third target point (X3, Y3, Z3). In 726, the user inputs to the control unit that the target is aligned and the control unit reads the position and orientation (not illustrated) of the head-mounted display provided by the position sensor. These read position and orientation are also kept for further calculations.

In 728, the control unit uses the read positions and orientations to calculate a translation matrix between the reference system (Xref, Yref, Zref) and the head-mounted display's system. The position (Xo, Yo, Zo) of the head-mounted display is consequently referenced relative to the reference system (Xref, Yref, Zref).

It is noted that during the referencing procedure, instructions to the user may be displayed using the display systems by the control unit.

An ambiguity as to the orientation of the head-mounted display still remains and the orientation needs to be referenced. In 730, a virtual plane corresponding to the target plane defined by the three target points ((X1, Y1, Z1); (X2, Y2, Z2); (X3, Y3, Z3)) is displayed in stereoscopy in the head-mounted display, according to the calculated translation matrix. In 732, the user aligns the virtual plane by superimposing it with the target plan using the user input and presses a user button to confirm the alignment. For best results, this step should be done with the best possible precision. In 734, the control unit reads the position and orientation (not illustrated) of the head-mounted display provided by the position sensor. In 736, the control unit calculates the rotation matrix between the reference system (Xref, Yref, Zref) and the head-mounted display's system using the known translation matrix and position and orientation of the head-mounted display for proper alignment to the target plane. The orientation (.theta.x, .theta.y, .theta.z) of the head-mounted display is consequently referenced relative to the reference system (Xref, Yref, Zref). The translation matrix is also validated. In 738, the calculated translation and rotation matrices are saved for use by the head-mounted display to visualize the subsurface medium. Accordingly, as the head-mounted display moves in space, their position (Xob, Yob, Zob) and orientation (.theta.xb, .theta.yb, .theta.zb) in the reference system (Xref, Yref, Zref) can be calculated in real-time.

It is noted that a similar referencing method can be used to reference a mono vision head-mounted display. Alternatively, the referencing of a stereoscopic head-mounted display 200 using cameras could be performed by using an image recognition method. The same three target points ((X1, Y1, Z1); (X2, Y2, Z2); (X3, Y3, Z3)) could be recognized on the two images provided by the cameras and the position and orientation of the head-mounted display in the reference system could be calculated using the known relative position of the cameras and the position of the target points on both images.

Alternatively, target points disposed in an immediate environment of the medium could be used instead of the sensors, especially if the surface is to be excavated or otherwise destroyed.

Additionally, the reference method may need to be repeated when going back to an already characterized subsurface medium and it may be required that the target point sensors be removed. The target points may the need to be relocated in the environment of the surface. Accordingly, three new target points are disposed on a wall, on any other structure. The new target points the are referenced in the reference system. This is done using an already referenced head-mounted display. The user aligns the crosshairs to each new target and aligns the new target plane in a manner similar to the above-described referencing method. The positions of the new target points are then saved in the model for later referencing of the head-mounted display and the old target points may be physically removed from the surface.

In the described example, a tomography is obtained by characterizing a medium under surface using a profiling system. One will understand that, if a 3-D characterization is available, this characterization could be used by the 3-D model processor to provide a 3-D graphical representation model of the medium. Furthermore, the images displayed to the user could represent a tomography around which or over which the user moves in space instead of a complete 3-D model. The 3-D model processor then only converts the tomography characterizing the medium and provided by a profiling system, into an appropriate 3-D graphical representation of the tomography.

While illustrated in the block diagrams as groups of discrete components communicating with each other via distinct data signal connections, it will be understood by those skilled in the art that the preferred embodiments may be provided by a combination of hardware and software components, with some components being implemented by a given function or operation of a hardware or software system, and many of the data paths illustrated being implemented by data communication within a computer application or operating system. The structure illustrated is thus provided for efficiency of teaching the present preferred embodiment.

Although the present invention has been described hereinabove by way of specific embodiments thereof, it can be modified, without departing from the spirit and nature of the subject invention as defined in the appended claims.

1. A head-mounted display apparatus for use by a user to visualize a characterization of a subsurface medium, said display apparatus comprising:
an input for receiving a model characterizing the subsurface medium in a three-dimensional representation, in a reference system, the model being provided using a profiling system;
a positioning sensor for sensing a position and orientation of a first eye of the user in said reference system;
a processing unit for perspectively projecting said model on a first surface located in front of the first eye with said first position and orientation, to provide a first image characterizing the subsurface medium; and
a first display system for displaying, on said first surface, said first image characterizing the subsurface medium in superimposition with a first image of a real environment in front of the first eye.

2. The head-mounted display apparatus as claimed in claim 1, further comprising a second display system for displaying, on a second surface located in front of a second eye of the user, a second image characterizing the subsurface medium in superimposition with an image of a real environment in front of the second eye, said processing unit being further for perspectively projecting said model on said second surface to provide said second image characterizing the subsurface medium, the characterization being thereby visualized in stereoscopy.

3. The head-mounted display apparatus as claimed in claim 2, further comprising a first and second camera, one disposed in front of each of the first and the second surface for providing said images of the real environment in front of the first and the second eye, said processing unit being further for superimposing said images characterizing the subsurface medium with said images of the real environment in front of the eyes.

4. The head-mounted display apparatus as claimed in claim 1, wherein said first display system comprises a see-through screen transmitting said image of a real environment, said first image characterizing the subsurface medium being displayed onto said see-through screen.

5. The head-mounted display apparatus as claimed in claim 1, wherein the characterization of the subsurface medium comprises a tomography.

6. The head-mounted display apparatus as claimed in claim 1, wherein said positioning sensor comprises a three-axis accelerometer translation sensor for referencing a position of said first eye in said reference system, and a three-axis accelerometer rotation sensor for referencing an orientation of said first eye in said reference system.

7. The head-mounted display apparatus as claimed in claim 1, wherein said profiling system comprises a plurality of system components exchanging messages through a communication interface, said system components comprising:
an energy impulse generator for transferring an energy pulse to said surface and comprising generator communication means for exchanging said messages with other system components;
a sensing assembly including sensors, each one of said sensors comprises an accelerometer for detecting an acceleration on said surface resulting from said energy pulse and producing a signal representative of said acceleration, each one of said sensors comprises an interface communication means for transmitting said signal representative of said acceleration and exchanging said messages with other system components through said communication interface; and
a user-computing interface comprising interface communication means for receiving said signal representative of said acceleration and exchanging said messages with other system components through said communication interface, and an interface processor for processing said received signal representative of said acceleration to produce said characterization of the subsurface medium.

8. A system for use by a user to visualize a characterization of a subsurface medium, the system comprising:
a profiling system for providing the characterization of the subsurface medium;
a three-dimensional model processor for processing said characterization of the subsurface medium to provide a model characterizing the subsurface medium in a three-dimensional graphical representation, in a reference system; and
a head-mounted display device having:
an input for receiving said model;
a positioning sensor for sensing a position and orientation of a first eye of the user in said reference system;
a processing unit for perspectively projecting said model on a first surface located in front of the first eye with said position and orientation, to provide a first image characterizing the subsurface medium; and
a first display system for displaying, on said first surface, said first image characterizing the subsurface medium in superimposition with an image of a real environment in front of the first eye.

9. The system as claimed in claim 8, wherein said head-mounted display device further has a second display system for displaying, on a second surface located in front of a second eye of the user, a second image characterizing the subsurface medium in superimposition with an image of a real environment in front of the second eye, said processing unit being further for perspectively projecting said model on said second surface to provide said second image characterizing the subsurface medium, the characterization being thereby visualized in stereoscopy.

10. The system as claimed in claim 9, further comprising a first and second camera, one disposed in front of each of the first and the second surfaces for providing said images of a real environment in front of the first and the second eye, said processing unit being further for superimposing said images characterizing the subsurface medium under the surface with said images of the real environment in front of the eyes.

11. The system as claimed in claim 8, wherein said first display system comprises a see-through screen transmitting said image of a real environment, said first image characterizing the subsurface medium being displayed onto said see-through screen.

12. The system as claimed in claim 8, wherein said characterization of the subsurface medium comprises a tomography.

13. The system as claimed in claim 8, wherein said three-dimensional modeling processor comprises a geotechnical-based three-dimensional modeling software.

14. The system as claimed in claim 8, wherein said positioning sensor comprises a three-axis accelerometer translation sensor for referencing a position of said first eye in said reference system, and a three-axis accelerometer rotation sensor for referencing an orientation of said first eye in said reference system.

15. The system as claimed in claim 8, wherein said profiling system comprises a plurality of system components exchanging messages through a communication interface.

16. The system as claimed in claim 15, wherein said system components comprise:
an energy impulse generator for transferring an energy pulse to said surface and comprising generator communication means for exchanging said messages with other system components;
a sensing assembly including sensors, each one of said sensors comprises an accelerometer for detecting an acceleration on said surface resulting from said energy pulse and producing a signal representative of said acceleration, each one of said sensors comprises an interface communication means for transmitting said signal representative of said acceleration and exchanging said messages with other system components through said communication interface; and
a user-computing interface comprising interface communication means for receiving said signal representative of said acceleration and exchanging said messages with other system components through said communication interface, and an interface processor for processing said received signal representative of said acceleration to produce said characterization of said subsurface medium.

17. A method for a user to visualize a characterization of a subsurface medium, the method comprising:
providing the characterization of the subsurface medium;
processing said characterization of the subsurface medium to provide a model characterizing the subsurface medium in a three dimensional graphical representation, in a reference system;
sensing a first position and orientation of a first eye of the user in said reference system;
defining a first surface located in front of said first eye;
perspectively projecting said model on a first surface located in front of the first eye to provide a first image characterizing the subsurface medium;
providing an image of a real environment in front of the first eye; and
displaying on said first surface said first image characterizing the subsurface medium in superimposition with said image of a real environment in front of the first eye.

18. The method as claimed in claim 17, further comprising:
determining a second position and orientation of the second eye of the user in said reference system with the first sensed position and orientation;
defining a second surface located in front of the second eye with said second position and orientation;
perspectively projecting said model on said second surface to provide a second image characterizing the subsurface medium;
providing an image of a real environment in front of the second eye; and
displaying on said second surface said second image characterizing the subsurface medium in superimposition with said image of a real environment in front of the second eye, the characterization being thereby visualized in stereoscopy.

19. The method as claimed in claim 18, further comprising:
acquiring said image of a real environment in front of the first eye; and
acquiring said image of a real environment in front of the second eye.

20. The method as claimed in claim 17, further comprising transmitting said image of a real environment through a see-through screen, said displaying comprising displaying said first image characterizing the subsurface medium on said see-through screen.

21. The method as claimed in claim 17, wherein said characterization of the subsurface medium comprises a tomography.

22. The method as claimed in claim 17, wherein said processing comprises using geotechnical-based modeling algorithm.

23. The method as claimed in claim 17, wherein said perspectively projecting comprises:
selecting regions of said subsurface medium having a given characteristic,
graphically representing said region to provide a three-dimensional graphical representation, and
perspectively projecting said graphical representation on said first surface to provide said first image characterizing the subsurface medium.

24. A head-mounted display apparatus for use by a user to visualize a characterization of a subsurface medium, said display apparatus comprising:
an input for receiving a model characterizing the subsurface medium in a three-dimensional representation, in a reference system;
a positioning sensor for sensing a position and orientation of a first eye of the user in said reference system;
a processing unit for perspectively projecting said model on a first surface located in front of the first eye with said first position and orientation, to provide a first image characterizing the subsurface medium; and
a first display system for displaying, on said first surface, said first image characterizing the subsurface medium in superimposition with a first image of a real environment in front of the first eye.

25. A portable head-mounted display apparatus for use by a user to visualize a characterization of a subsurface medium, said display apparatus comprising:
an input for receiving, from a model processor, a model characterizing the subsurface medium in a three-dimensional graphical representation, in a reference system;
a memory for saving said model, said input to be disconnected from said model processor after saving said model;
a positioning sensor for sensing a position and orientation of the head-mounted display apparatus in said reference system;
a processing unit for determining a pair of stereoscopic images characterizing the subsurface medium, using said model and said position and orientation; and
a stereoscopic display systems for displaying, in front of the eyes of the user, said pair of stereoscopic images characterizing the subsurface medium in superimposition with a pair of images of a real environment.
